(19) United States
(12) Patent Application Publication
(10) Pub. No.: US 2021/0208773 A1
(43) Pub. Date: Jul. 8, 2021

(54) DISPLAY APPARATUS AND CONTROLLING METHOD THEREOF

(71) Applicant: Samsung Electronics Co., Ltd., Suwon-si (KR)

(72) Inventors: Sunhye KIM, Suwon-si (KR); Yangwook KIM, Suwon-si (KR)

(21) Appl. No.: 17/111,932

(22) Filed: Dec. 4, 2020

(30) Foreign Application Priority Data
Jan. 3, 2020 (KR) 10-2020-0001058

(51) Int. Cl. G06F 3/0485; G06F 3/0483; G06F 3/0488

(52) U.S. Cl. CPC G06F 3/04855; G06F 3/0488; G06F 3/0483

(57) ABSTRACT

A display apparatus is provided. The display apparatus includes a display, a memory configured to store at least one instruction, and a processor, connected to the display and the memory, configured to control the display apparatus, and the processor is further configured to control the display to display a content, based on receiving a first user input corresponding to a region of the content, control the display to display a marker at a specific region of a scroll bar corresponding to the one region, and based on receiving a second user input with respect to the marker, control the display to display a region of the content.

### CROSS-REFERENCE TO RELATED APPLICATION(S)

This application is based on and claims priority under 35 U.S.C. § 119(a) of a Korean patent application number 10-2020-0001058, filed on Jan. 3, 2020, in the Korean Intellectual Property Office, the disclosure of which is incorporated by reference herein in its entirety.

### BACKGROUND

### 1. Field

The disclosure relates to a display apparatus and a controlling method thereof. More particularly, the disclosure relates to a display apparatus displaying a content and a scroll bar and a controlling method thereof.

### 2. Description of Related Art

Various types of electronic devices have been developed and distributed by the advancement of electronic technology. In particular, a most widely used mobile device and a display apparatus, such as a television (TV) have been advanced rapidly in recent years.

A format of a content provided to a user has been diversified and a volume of a content becomes vast.

A user tends to read a vast amount of content while scrolling rapidly, instead of reading it over a long period of time due to reasons that a user may lose interest easily and there is time limit, or the like. Therefore, there is a need to provide a user with summarized content with high accuracy and reliability.

In addition, there is a need for a user to easily bookmark a part including interested information included in a vast amount of content, and to easily load the corresponding part at any desirable time.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a display apparatus for easily bookmarking a part including a user's interested information in a content and a controlling method thereof.

Additional aspects will be set forth in part in the description which follows and, in part, will be apparent from the description, or may be learned by practice of the presented embodiments.

In accordance with an aspect of the disclosure, a display apparatus is provided. The apparatus includes a display, a memory configured to store at least one instruction, and a processor, connected to the display and the memory, configured to control the display apparatus, and the processor is further configured to control the display to display a content, based on receiving a first user input corresponding to a first region of the content, control the display to display a marker at a specific region of a scroll bar corresponding to a second region, and based on receiving a second user input with respect to the marker, control the display to display the first region of the content, and the specific region is a region corresponding to the second region in a scroll bar for scrolling the content.

In accordance with another aspect of the disclosure, a method of controlling a display apparatus is provided. The method includes displaying a content, based on receiving a first user input corresponding to a first region of the content, displaying a marker at a specific region, and based on receiving a second user input with respect to the marker in a display of another region of the content, displaying a second region of the content, and the specific region is a region corresponding to the second region in a scroll bar for scrolling the content.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of a display apparatus according to an embodiment of the disclosure;

FIG. 2 is a diagram illustrating a marker according to an embodiment of the disclosure;

FIG. 3 is a diagram illustrating a case of moving to one region of a content according to an embodiment of the disclosure;

FIG. 4 is a diagram illustrating a method of removing a marker according to an embodiment of the disclosure;

FIG. 5 is a diagram illustrating a scroll bar according to an embodiment of the disclosure;

FIG. 6 is a diagram illustrating a marker and identification information according to an embodiment of the disclosure;

FIG. 7 is a diagram illustrating a thumbnail image according to an embodiment of the disclosure;

FIG. 8 is a diagram illustrating a method of obtaining keyword information according to an embodiment of the disclosure;

FIG. 9 is a diagram illustrating a method of obtaining summary information according to an embodiment of the disclosure;

FIG. 10 is a detailed block diagram of a display apparatus according to an embodiment of the disclosure;

FIG. 11 is a diagram illustrating a marker according to an embodiment of the disclosure;

FIG. 12 is a diagram illustrating a method of storing a marker according to an embodiment of the disclosure;

FIG. 13 is a diagram illustrating a method of sharing a marker according to an embodiment of the disclosure; and

FIG. 14 is a flowchart illustrating a controlling method of a display apparatus according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terms, such as “have,” “may have,” “comprise,” or “may comprise,” used herein to designate a presence of a characteristic (e.g., an element, such as number, function, operation, or a component) and do not to preclude a presence of other characteristics.

Expressions, such as “at least one of A and/or B” and “at least one of A and B” should be understood to represent “A,” “B” or “A and B.”

Terms, such as “first,” “second,” and the like may be used to describe various components regardless of order and/or importance, but the components should not be limited by the terms. The terms are used to distinguish a component from another.

In addition, a description that one element (e.g., a first element) is “(operatively or communicatively) coupled with/to” or “connected to” another element (e.g., a second element) should be interpreted to include both the case that the one element is directly coupled to the other element, and the case that the one element is coupled to the another element through still another element (e.g., a third element).

It is to be understood that the terms, such as “comprise” or “consist of” are used herein to designate a presence of a characteristic, number, step, operation, element, component, or a combination thereof, and do not to preclude a presence or a possibility of adding one or more of other characteristics, numbers, steps, operations, elements, components or a combination thereof.

A term, such as “module,” “unit,” “part,” and so on is used to refer to an element that performs at least one function or operation, and such element may be implemented as hardware or software, or a combination of hardware and software. Further, other than when each of a plurality of “modules,” “units,” “parts,” and the like must be realized in an individual hardware, the components may be integrated in at least one module and be realized in at least one processor (not shown).

In the following description, a term “user” may refer to a person using an electronic device, or a device (for example, an artificial intelligence electronic device) using an electronic device.

Hereinafter, non-limiting embodiments of the disclosure will be described in detail with reference to the accompanying drawings.

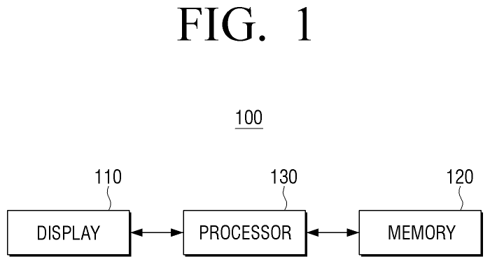

FIG. 1 is a block diagram illustrating a configuration of a display apparatus according to an embodiment of the disclosure.

Referring to FIG. 1, a display apparatus 100 according to various embodiments may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), a moving picture experts group phase 1 or phase 2 (MPEG-1 or MPEG-2) audio layer-3 (MP3) player, a medical device, a camera, a virtual reality (VR) device, or a wearable device. The wearable device may include at least one of an accessory type (e.g., a watch, a ring, a bracelet, an ankle bracelet, a necklace, a pair of glasses, a contact lens or a head-mounted-device (HMD)), a fabric or a garment-embedded type (e.g., electronic cloth), skin-attached type (e.g., a skin pad or a tattoo), or a bio-implantable circuit. In some embodiments of the disclosure, the display apparatus may include at least one of, for example, a television, a digital video disk (DVD) player, an audio system, a refrigerator, air-conditioner, a cleaner, an oven, a microwave, a washing machine, an air purifier, a set top box, a home automation control panel, a security control panel, a media box (e.g., SAMSUNG HOMESYNC™, APPLE TV™, or GOOGLE TV™), a game console (e.g., XBOX™, PLAYSTATION™), an electronic dictionary, an electronic key, a camcorder, or an electronic frame.

In other embodiments of the disclosure, the display apparatus may include at least one of a variety of medical devices (e.g., various portable medical measurement devices, such as a blood glucose meter, a heart rate meter, a blood pressure meter, or a temperature measuring device), magnetic resonance angiography (MRA), magnetic resonance imaging (MRI), computed tomography (CT), a capturing device, or a ultrasonic wave device, and the like), a navigation system, a global navigation satellite system (GNSS), an event data recorder (EDR), a flight data recorder (FDR), an automotive infotainment devices, a marine electronic equipment (e.g., marine navigation devices, gyro compasses, and the like), avionics, a security device, a car head unit, industrial or domestic robots, a drone, an automated teller machine (ATM) of a financial institution, a point of sale (POS) of a store, or an Internet of Things (IoT) device (e.g., light bulbs, sensors, sprinkler devices, fire alarms, thermostats, street lights, toasters, exercise equipment, hot water tanks, heater, boiler, and the like).

The display apparatus 100 according to an embodiment may display various types of contents. The display apparatus 100 may be implemented as a user terminal device, but is not limited thereto, and may be applicable to any device having a display function, such as a video wall, a large format display (LFD), a digital signage, and a digital information display (DID), a projector display, or the like. In addition, the display apparatus 100 may be implemented as various types displays, such as a liquid crystal display (LCD), an organic light-emitting diode (OLED), a liquid crystal on silicon (LCoS), a digital light processing (DLP), a quantum dot (QD) display panel, a quantum dot light-emitting diodes (QLED), a micro LED, a mini LED, or the like. The display apparatus 100 may be implemented as a touch screen coupled to a touch sensor, a flexible display, a rollable display, a third-dimensional (3D) display, a display in which a plurality of display modules are physically connected, or the like.

The display apparatus 100 according to an embodiment may include a display 110, a memory 120, and a processor 130.

The display 110 may be implemented as a display including a self-emitting element or a display including a non-self-limiting element and a backlight. For example, the display 110 may be implemented as a display of various types, such as, for example, and without limitation, a liquid crystal display (LCD), organic light emitting diodes (OLED) display, light emitting diodes (LED), micro LED, mini LED, plasma display panel (PDP), quantum dot (QD) display, quantum dot light-emitting diodes (QLED), or the like. In the display 110, a backlight unit, a driving circuit which may be implemented as an a-si TFT, low temperature poly silicon (LTPS) TFT, organic TFT (OTFT), or the like, may be included as well. The display 110 may be implemented as a touch screen coupled to a touch sensor, a flexible display, a rollable display, a third-dimensional (3D) display, a display in which a plurality of display modules are physically connected, or the like. The display 110 may display various contents according to the control of the processor 130.

The memory 120 may store data necessary for various embodiments of the disclosure. The memory 120 may be implemented as a memory embedded in the display apparatus 100, or may be implemented as a removable or modular memory in the display apparatus 100, according to the data usage purpose. For example, data for driving the display apparatus 100 may be stored in a memory embedded in the display apparatus 100, and data for an additional function of the display apparatus 100 may be stored in the memory detachable to the display apparatus 100. A memory embedded in the display apparatus 100 may be a volatile memory, such as a dynamic random access memory (DRAM), a static random access memory (SRAM), a synchronous dynamic random access memory (SDRAM), or a nonvolatile memory (for example, one time programmable ROM (OTPROM), programmable ROM (PROM), erasable and programmable ROM (EPROM), electrically erasable and programmable ROM (EEPROM), mask ROM, flash ROM, a flash memory (for example, NAND flash or NOR flash), a hard disk drive or a solid state drive (SSD), or the like. In the case of a memory detachably mounted to the display apparatus 100, the memory may be implemented as a memory card (for example, a compact flash (CF), secure digital (SD), micro secure digital (micro-SD), mini secure digital (mini-SD), extreme digital (xD), multi-media card (MMC), and the like), an external memory (for example, a USB memory) connectable to the USB port, or the like, but the memory is not limited thereto.

According to an embodiment of the disclosure, the memory 120 may store at least one instruction to control the display apparatus 100 or a computer program including instructions.

In the embodiment described above, various data are stored in an external memory of the processor 130, but at least a part of the above data may be stored in an internal memory of the processor 130 according to an implementation embodiment of at least one of the display apparatus 100 or the processor 130.

The processor 130, electrically connected to the memory 120, controls overall operations of the display apparatus 100. The processor 130 may include one or a plurality of processors. The processor 130 may, by executing at least one instruction stored in the memory 120, perform an operation of the display apparatus 100 according to various embodiments.

The processor 130 according to an embodiment may be implemented with, for example, and without limitation, a digital signal processor (DSP) for image-processing of a digital image signal, a microprocessor, a graphics processor (GPU), an artificial intelligence (AI) processor, a neural processor (NPU), a time controller (TCON), or the like, but the processor is not limited thereto. The processor 130 may include, for example, and without limitation, one or more among a central processor (CPU), a micro controller unit (MCU), a micro-processor (MPU), a controller, an application processor (AP), a communication processor (CP), an advanced reduced instruction set computing (RISC) machine (ARM) processor, a dedicated processor, or may be defined as a corresponding term. The processor 130 may be implemented in a system on chip (SoC) type or a large scale integration (LSI) type which a processing algorithm is built therein, application specific integrated circuit (ASIC), or in a field programmable gate array (FPGA) type.

The processor 130 according to an embodiment may control the display 110 to display content and a scroll bar to scroll the content.

The content may mean all content in a web site including information, articles, photos, videos, bulletin boards, or the like. However, this is an embodiment and is not limited thereto. In one example, content according to various embodiments may refer to all scrollable content, such as various text, e-books, pictures, or videos, as represented by applications, programs, or the like, that are driven by the display apparatus 100, in addition to content within the website.

The processor 130 may display content and a scroll bar for scrolling the content. Here, the scroll bar is an example and is not limited thereto. The processor 130 may display various types of content search user interface (UI) for searching for content.

The processor 130 may also display an indicating graphical user interface (GUI) that is movable within the scroll bar and indicates a current scroll position. The processor 130 according to one embodiment may continuously display the scroll bar and the indicating GUI in the scroll bar, or may display the scroll bar and the indicating GUI only when the user's touch is detected. The indicating GUI may be referred to as a scroll bar slider, a scroll bar handler, a scroll bar controller, or the like, but will hereinafter be referred to as an indicating GUI for convenience.

The user's touch can be a touch having directionality. In one example, the user's touch may be a touch having directionality in up, down, left or right directions. In the following description, for convenience, a user's touch is defined as a touch having up and down directionality, and an indicating GUI is assumed to be a GUI of a bar-shape that is vertically movable in a scroll bar. This is merely exemplary, and is not limited thereto. For example, the user's touch can be a touch with left and right directionality, and the indicating GUI can be a bar-shaped GUI that is movable in the left and right directions within the scroll bar.

The processor 130 according to an embodiment may move the indicating GUI within a scroll bar according to a user's touch and may provide one region corresponding a position of the indicating GUI in the content through the display 110.

As information included in a content, a quantity of a text, a photo, or the like are vast as compared to the size of the display 110, the processor 130 may preferentially display only a region in a content, instead of displaying all the information, texts, and photos included in a content on a screen, and may display another region in a content according to scrolling.

Various embodiments of marking (or scrapping) a region, a region of interest in a content will be described, in addition to a method of registering favorites by scrapping or bookmarking a content, for example a website, using a uniform resource locator (URL) of a website.

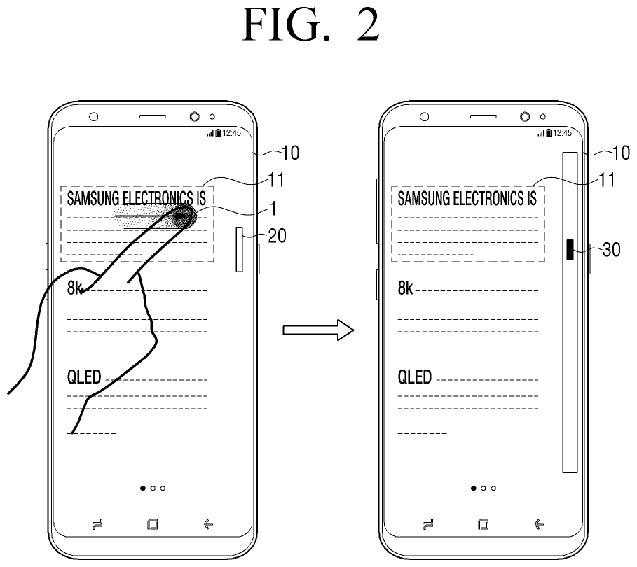

FIG. 2 is a diagram illustrating a marker according to an embodiment of the disclosure.

Referring to FIG. 2, the processor 130 may display a content 10 and a scroll bar for scrolling the content 10. The processor 130 according to one embodiment may display an indicating graphical user interface (GUI) 20 representing a current scroll position. The content 10 may include a region that is displayed and a region that is not displayed through the display 110. For example, if a total volume of the content 10 exceeds a volume that is displayable at a time through the display 110, the processor 130 may control the display 110 to display only a portion of the total volume of the content 10. The processor 130 may display a region 11 corresponding to a relative position of the indicating GUI 20 with respect to the total volume (or total length) of the content 10.

The processor 130 according to an embodiment may continuously display a scroll bar for scrolling the content 10, but is not limited thereto. For example, the processor 130 may display the scroll bar only when the user's touch is detected. The user's touch may refer to a touch input for scrolling the content 10.

Based on receiving a first user input 1 corresponding to one region 11 of the content 10, the processor 130 can display a marker in a specific region of the scroll bar corresponding to the one region 11. Here, the specific region of the scroll bar may refer to a display region of the indicating GUI 20 representing the current scroll position.

The first user input 1 according to one embodiment may refer to a swipe input. In one example, the processor 130 may generate a marker 30 in a particular region of the scroll bar corresponding to the one region 11 or a display region of the indicating GUI 20 when a drag input is received in a direction close to the scroll bar following a press input to the one region 11. The marker 30 may be referred to as a scrap, an identifier, a bookmark, or the like, but will hereinafter be referred to as a marker 30 for convenience.

The one region 11 can mean a region of a predetermined size corresponding to the position where the first user input 1 is detected. For example, the processor 130 may identify a predetermined number of sentences as the one region 11 based on the location at which the first user input 1 is detected. As another example, the processor 130 may identify a paragraph as the one region 11 based on the location at which the first user input 10 is detected.

As another example, the processor 130 may identify all the texts, still images, or moving images displayed through the display 110 as one region 11.

A first user input may be in various formats other than swipe input. For example, the first user input may be a tap input greater than or equal to a threshold time, a force touch input greater than or equal to a threshold intensity, or a double tap input.

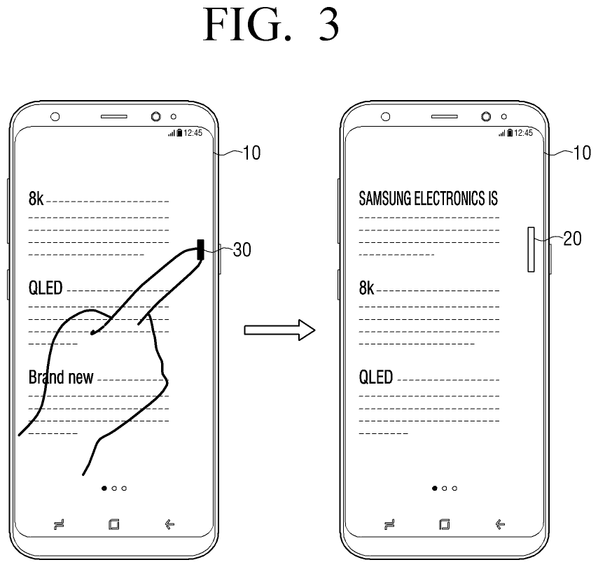

The processor 130 may, based on receiving a second user input with respect to the marker 30 while another region is being displayed, not one region 11 of the content 10, control the display 110 to display the one region 11 of the content 10. For example, the processor 130 may control the display 110 to move to one region 11 of the content 10 to display one region 11 in response to a second user input while the other area is being displayed. The detailed description thereof will be described with reference to FIG. 3.

FIG. 3 is a diagram illustrating a case of moving to one region of a content according to an embodiment of the disclosure.

Referring to FIG. 3, the processor 130 may sequentially scroll and display the content 10 according to a user input. For example, if the user input is up/down swipe input, the processor 130 may scroll the content 10 up/down according to a user input, and may move the indicating GUI 20 in the scroll bar.

Based on receiving the second user input 2 with respect to the marker 30 according to an embodiment of the disclosure, the processor 130 may display the one region 11 of the content 10 corresponding to the marker 30.

The second user input may be a tap input. Based on receiving a tap input (or a touch input) for the marker 30, the processor 130 may move to one region 11 of the content 10 corresponding to the marker 30 to display text, still images or moving images included in the one region 11. According to various embodiments of the disclosure, the scroll bar has been described above as being continuously displayed, the processor 130 may display the scroll bar only for a threshold amount of time when the user's touch input is detected, and may provide similar visual effects, such as displaying the scroll bar transparently and displaying only the indicating GUI 20.

According to FIGS. 2 and 3, only one marker 30 is illustrated for convenience, but the embodiment is not limited thereto. For example, the processor 130 may generate a plurality of markers according to the first user input 1, and each of the plurality of markers may correspond to a different region within the content 10.

The processor 130 according to one embodiment may store marker information in the memory 120 in accordance with the creation of the marker 30. For example, the processor 130 may map the content 10 and the marker 30 generated in the content 10 to obtain marker information and store the marker information in the memory 120. The processor 130 may then display the marker 30 mapped to the content 10 based on the marker information when loading the content 10.

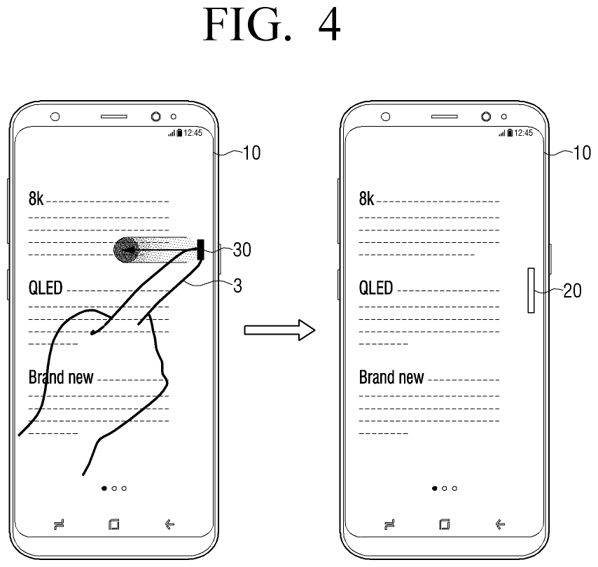

The processor 130 according to one embodiment may, based on receiving a third user input with respect to the marker 30, remove the marker 30 displayed in a particular region of the scroll bar. If the marker 30 is removed, the processor 130 may update the marker information corresponding to the content 10 and store the updated marker information in the memory 120. The detailed description thereof will be described with reference to FIG. 4.

FIG. 4 is a diagram illustrating a method of removing a marker according to an embodiment of the disclosure.

Referring to FIG. 4, based on receiving a third user input 3 with respect to the marker 30, the processor 130 may remove the marker 30. Here, the third user input 3 may refer to a swipe input. In one example, the processor 130 may, based on receiving a drag input in a direction distancing from a scroll bar following a press input with respect to the marker 30, remove the marker 30 displayed in a particular region of the scroll bar.

The third user input 3 may be an input in a type different from the first user input 1 and the second user input 2. For example, the first user input 1 and the third user input 3 may have different swipe directions. When the second user input 2 may include a tap input, the third user input 3 may include a swipe input.

As another example, the second user input 2 may be a tap input less than a threshold time, and the third user input 3 may be a tap input exceeding a threshold time. The processor 130 according to an embodiment may, based on receiving a tap input exceeding a threshold time with respect to the marker 30, remove the marker 30.

The processor 130 may update the marker information according to generation and removal of the marker 30, map the updated marker information to the content 10, and store the same.

The processor 130 according to an embodiment may obtain first marker information corresponding to the first content in displaying the first content. The processor 130 may then display the first content and a scroll bar for scrolling the first content. The processor 130 may display the first marker in a particular region of the scroll bar based on the first marker information corresponding to the first content. The first marker may correspond to a region of the first content. The processor 130, based on receiving the second user input with respect to the first marker, may display a region of the first content corresponding to the first marker.

The processor 130 may further display the marker according to a first user input for a region of the first content, and may remove the displayed marker according to a third user input to the marker. The processor 130 may then update the first marker information corresponding to the first content according to the addition or deletion of the marker.

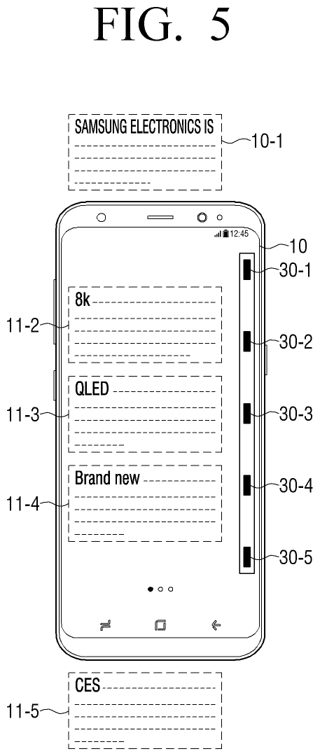

FIG. 5 is a diagram illustrating a scroll bar according to an embodiment of the disclosure.

The length of the scroll bar displayed on the display 110 according to one embodiment corresponds to the entire length of the scrollable content 10. Referring to FIG. 5, based on the indicating GUI being located at the top of the scroll bar, the processor 130 may control the display 110 to display a first region 11-1 located at the top within the content 10. Further, if the indicating GUI is located at the bottom of the scroll bar, the processor 130 may control the display 110 to display the fifth region 11-5 located at the bottom of the content 10.

FIG. 5 illustrates a case in which a region is divided in paragraph unit for convenience.

According to an embodiment of the disclosure, based on receiving the first user input 1 in the first region 11-1 of the content, the processor 130 may display a first marker 30-1 corresponding to the first region 11-1 in a specific region of the scroll bar. Here, the specific region may correspond to a relative position of the first region 11-1 relative to the entire length of the content 10.

Referring to FIG. 5, on the display 110 of the display apparatus 100, the second to fourth regions 11-2, 11-3, and 11-4 are displayed. The processor 130 according to one embodiment may, based on receiving the first user input 1 in the second region 11-2, display a second marker 31-2 in a region corresponding to a relative position of the second area region 1-2 with respect to the entire length of the content 10 in the scroll bar, rather than displaying the second marker 31-2 corresponding to the second region 11-2 on the top of the scroll bar even though the second region 11-2 is located at the top of the screen. Accordingly, the second marker 30-2 may be displayed at a lower end than the first marker 30-1 corresponding to the first region 11-1.

FIG. 5 illustrates a case where the first to fifth markers 30-1, 30-2, 30-3, 30-4, and 30-5 are generated as the first user input 10 is received in each of the first to fifth regions 11-1, 11-2, 11-3, 11-4, and 11-5 of the content 10 for convenience. However, this is merely exemplary, and is not limited thereto.

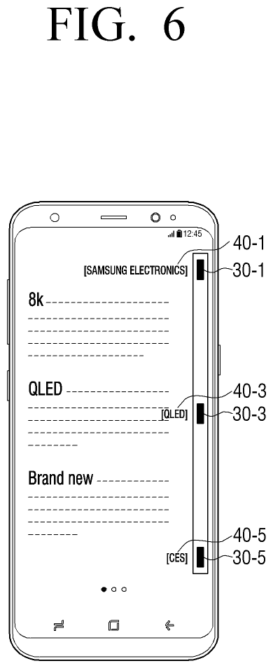

Based on receiving the first user input 1, the processor 130 according to an embodiment can display identification information for identifying contents of the one region 11 of the marker 30 in a specific region of the scroll bar corresponding to the one region 11. The detailed description thereof will be described with reference to FIG. 6.

FIG. 6 is a diagram illustrating a marker and identification information according to an embodiment of the disclosure.

Referring to FIG. 6, the processor 130 according to one embodiment may display the marker 30 and identification information 40. For example, if the first user input 1 is received in one region 11, the processor 130 can display the marker 30 in a particular region on the scroll bar corresponding to one region 11. The processor 130 may display identification information 40 for identifying one region 11 adjacent to the marker 30 based on text, still images, moving images, or the like, included in one region 11.

For example, the processor 130 may obtain “Samsung Electronics” as identification information 40-1 of the first region 11-1 based on the text included in the first region 11-1. The processor 130 may display “Samsung Electronics” at a positon adjacent to the first marker 30-1 corresponding to the first region.

Even when a vast amount of text is displayed, the processor 130 may mark (or scrap, bookmark) the first region 11-1 according to the user's intent, and the processor 130 may provide identification information 40 for identifying content (e.g., text, still images, and the like) included in the first region 11-1, along with the first marker 30-1.

Referring to FIGS. 5 and 6, the processor 130 may display only the marker 30, and may also display identification 40 for identifying the marker 30 and content in the one region 11 corresponding to the marker 30.

Referring to FIG. 6, the processor 130 according to one embodiment may display the marker 30-1 corresponding to the first region 11-1 and “Samsung Electronics” which is the identification information 40-1 corresponding to the first region 11-1, display a marker 30-3 corresponding to a third region 11-3 and the identification information 40-3 “QLED” corresponding to the third region 11-3, and display a marker 30-5 corresponding to a fifth region 11-5 and identification information “CES” corresponding to the fifth region 11-5. Based on receiving a second user input 2 for the marker 30 or the identification information 40, the processor 130 may display the corresponding one region 11. For example, based on receiving the second user input 2 corresponding to the identification information 40-1 “Samsung Electronics” corresponding to the first region 11-1 or the first marker 30-1, the processor 130 may control the display 110 to display the first region 11-1.

The identification information 40 for identifying the contents of one region 11 can include at least one of keyword information included in one region 11 or a thumbnail image associated with the one region 11.

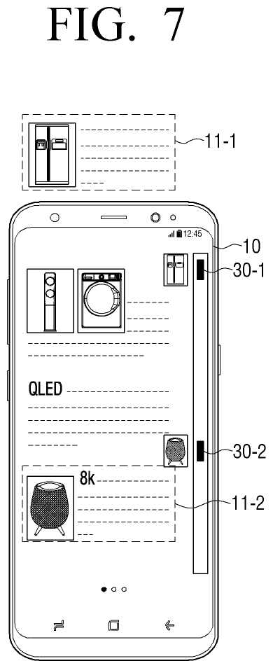

For example, the identification information 40 may be keyword information obtained based on the text included in one region 11, as illustrated in FIG. 6. As another example, the identification information 40 may be a thumbnail image or a capture image obtained based on a still image and a moving image included in the one region 11. The detailed description thereof will be described with reference to FIG. 7.

FIG. 7 is a diagram illustrating a thumbnail image according to an embodiment of the disclosure.

Referring to FIG. 7, the content of the first region 11-1 may include an image and a text. Based on receiving the first user input 1 corresponding to the first region 11-1, the processor 130 according to an embodiment can display the first marker 30-1 on a specific region of the scroll bar corresponding to the first region 11-1. The processor 130 may display the first identification information 40-1 corresponding to the first region 11-1 along with the first marker 30-1. The first identification information 40-1 may be obtained based on the text included in the contents of the first region 11-1, and may be obtained based on the image.

For example, the processor 130 may obtain the image included in the first region 11-1 as the identification information 40-1, and display the first marker 30-1 and the identification information 40-1 in a specific region on the scroll bar corresponding to the first region 11-1.

FIG. 7 illustrates the image included in the first region 11-1 as the identification information 40-1 for convenience, but the embodiment is not limited thereto.

For example, the processor 130 may obtain the text and the image included in the first region 11-1 as the identification information corresponding to the first region 11-1.

Hereinafter, a method for obtaining identification information 40 corresponding to one region 11 based on the contents included in one region 11 will be described according to various embodiments.

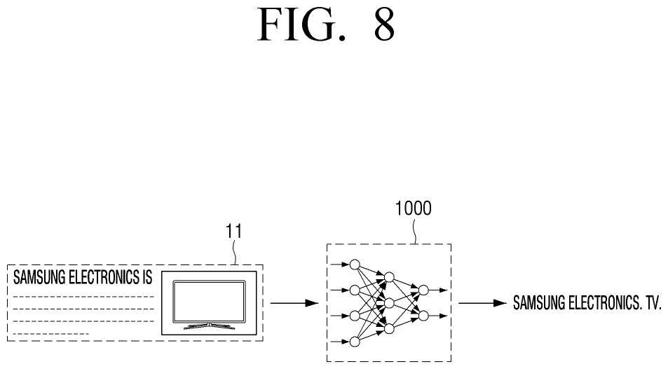

FIG. 8 is a diagram illustrating a method of obtaining keyword information according to an embodiment of the disclosure.

According to an embodiment of the disclosure, based on receiving the first user input 1 in the one region 11, the processor 130 can identify a data object model (DOM) element of the one region 11. Based on the text being included in the one region 11, the processor 130 may then obtain the text. The processor 130 may classify the obtained text into word units to obtain a plurality of words, and assign different weights to each of the plurality of words based on the frequency of each word in the content 10, the proximity relationship between the words, a title of the content 10, or the like. The processor 130 may then obtain at least one word among the plurality of words as a representative keyword of the one region 11.

As another example, the processor 130 may obtain a representative keyword of the one region 11 based on a predetermined number of words that are most initially located in the text included in the one region 11.

The processor 130 can display the obtained representative keyword together with the marker 30 corresponding to the one region 11, as illustrated in FIG. 6. For convenience, the identification information 40 is defined as keyword information, representative keyword, or the like, in the case where the identification information 40 is in a form of a text, but this is only one example, and is not limited thereto.

As another example, if a text is not included in one region 11, the processor 130 may obtain the identification information 40 of the one region 11 based on an image included in the one region 11, the captured image of the one region 11, or the like.

As another example, the processor 130 may obtain representative keyword information corresponding to the one region 11 of the content 10 using an artificial intelligence model.

One or more artificial intelligence models may be stored in the memory 120 according to one embodiment. The memory 120 according to an embodiment may store a first artificial intelligence model 1000 that is trained to obtain representative keyword information from input data. Here, the first artificial intelligence model 1000 is a model trained using a plurality of sample data, and can be an artificial intelligence model trained to obtain representative keyword information based on text, still images or moving images included in each of the plurality of sample data.

Referring to FIG. 8, based on receiving the first user input 1 in one region 11, the processor 130 can obtain representative keyword information of the one region 11 using the first artificial intelligence model 1000. Here, the representative keyword information may be an example of the identification information 40. For example, the identification information 40 may include a location of the one region 11 in the content 10, time information at which the first user input 1 is received, representative keyword information of the one region 11, or the like.

Referring to FIG. 8, the processor 130 may obtain “Samsung Electronics”, “TV”, or the like, as representative keyword information of the one region 11 using the first artificial intelligence model 1000. The processor 130 can display the marker 30 and the representative keyword information corresponding to the one region 11 together on the scroll bar.

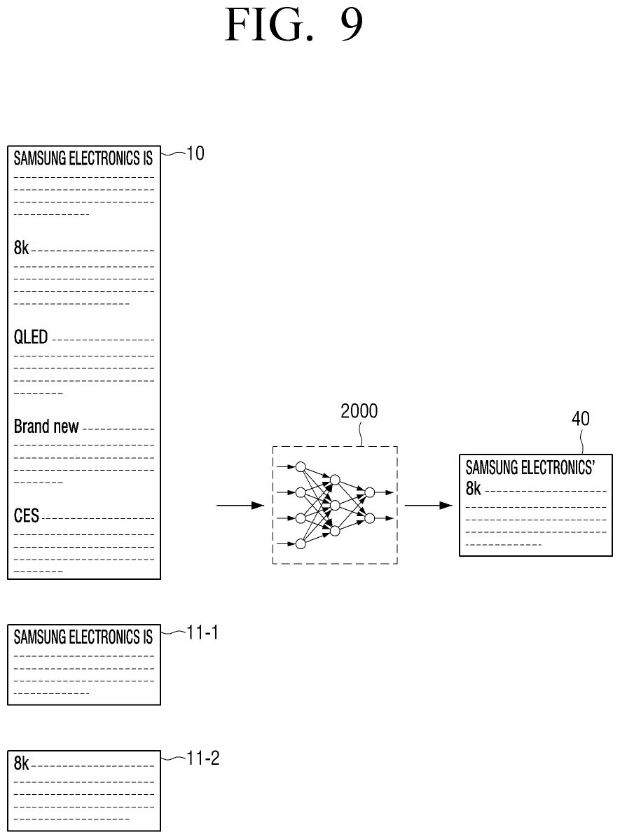

FIG. 9 is a diagram illustrating a method of obtaining summary information according to an embodiment of the disclosure.

The processor 130 according to an embodiment may provide a user with summary information of the content 10 including a vast amount of texts, still images, moving images, or the like.

Referring to FIG. 9, the processor 130 according to an embodiment may obtain summary information of the content 10 based on text, still images, moving images, or the like, included in the one region 11 corresponding to the marker 30. Since the one region 11 corresponding to the marker 30 generated according to the first user input 1 may further include information (e.g., text) in which the user has more interest, than other regions in the content 10, the processor 130 may assign a relatively higher weight than the other regions in the content 10 to the one region 11 at which the first user input 1 is received, thereby obtaining summary information corresponding to the content 10.

Referring to FIG. 9, the memory 120 according to an embodiment may be stored with a second artificial intelligence model 2000 that is trained to obtain summary information 50 from the input data. For example, the second artificial intelligence model 2000 may obtain summary information 50 from the input data based on a machine reading comprehension (MRC) model. Here, the MRC model can refer to a machine-readable model for reading and interpreting input data based on an artificial intelligence (AI) algorithm. For example, the MRC model may analyze and summarize the input data using a natural language processing (NLP) algorithm trained based on various types of deep learning, such as a recurrent neural network (RNN), convolution neural network (CNN), or the like.

The processor 130 according to an embodiment can obtain summary information 50 corresponding to the content data corresponding to the at least one marker 30 displayed on the scroll bar using the second artificial intelligence model 2000. Referring to FIG. 9, the processor 130 may apply the content 10, the first region 11-1 (or the first content data) corresponding to the first marker 30-1, and the second region 11-2 (or second content data) corresponding to the second marker 30-2 to the second artificial intelligence model 2000. The processor 130 may then obtain summary information 50 corresponding to the content 10 from the second artificial intelligence model 2000. The content data corresponding to the first marker 30-1 and the second marker 30-2 may be given a relatively higher weight than other data in the content 10, and the summary information 50 obtained from the second artificial intelligence model 2000 may include text, images, or the like, included in the content data corresponding to the first and second markers 30-1 and 30-2.

The processor 130 according to an embodiment may obtain summary information 50 corresponding to the content 10 based on at least one marker generated in the content 10 by another user.

For example, the processor 130 may receive information on at least one marker generated in the content 10 from an external device, in addition to the marker 30 generated by the user of the display apparatus 100, and may obtain summary information 50 corresponding to the content 10 based on information on the received marker.

Referring to FIG. 9, based on receiving marking information associated with the content 10, the processor 130 may identify one region 11 of the content 10 based on the marking information. Here, the marking information may include information about identified region of the content 10 based on a marker generated in the content 10 by another user. For example, the processor 130 may identify a first region 11-1 corresponding to the first marker 30-1 for the content 10 and a second region 11-2 corresponding to the second marker 30-2 based on the marking information received from the external device.

The processor 130 according to one embodiment may display the identified first and second markers 30-1, 30-2 in different colors based on the marker 30 generated by the user of the display apparatus 100 and the marking information received from the external device. However, this is merely exemplary and is not limited thereto. For example, the processor 130 may display the identified first and second markers 30-1, 30-2 at different sizes or display different locations based on the marker 30 generated by the user and the marking information received from the external device.

As another example, the processor 130 may display the first marker 30-1 and the second marker 30-2 in different colors or different sizes based on the number of markings by another user. For example, if the first region 11-1 corresponding to the first marker 30-1 has been marked for more than a threshold number of times by a plurality of other users, a different color (e.g., red) or a different size (e.g., the first marker 30-1) may be displayed with a different color (e.g., red) or a different size (e.g., the first marker 30-1 is relatively large) to emphasize the first marker 30-1. The second region 11-2 corresponding to the second marker 30-2 may be a region where the marking is performed by less than a threshold number by a plurality of other users.

The processor 130 may apply the content 10, the first region 11-1 and the second region 11-2 to the second artificial intelligence model 2000 to obtain summary information 50 corresponding to the content 10.

Here, that the AI model is being trained may refer to a predetermined operating rule or AI model set to perform a desired feature (or purpose) is made by making a basic AI model (e.g., AI model including arbitrary random parameters) trained using various training data using learning algorithm. The learning may be accomplished through a separate server and/or system, but is not limited thereto and may be implemented in an electronic apparatus. Examples of learning algorithms include, but are not limited to, supervised learning, unsupervised learning, semi-supervised learning, or reinforcement learning.

The first and second artificial intelligence models 1000, 2000 may include, for example, but is not limited to, convolutional neural network (CNN), recurrent neural network (RNN), restricted Boltzmann machine (RBM), deep belief network (DBN), bidirectional recurrent deep neural network (BRDNN), deep Q-networks, or the like.

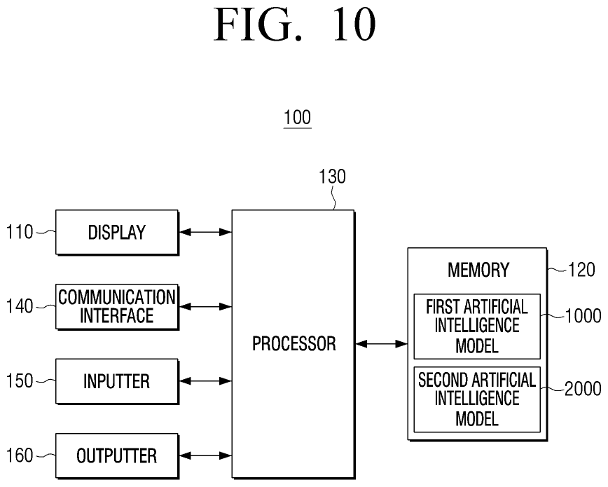

FIG. 10 is a detailed block diagram of a display apparatus according to an embodiment of the disclosure.

Referring to FIG. 10, the display apparatus 100 includes the display 110, the memory 120, the processor 130, a communication interface 140, an inputter 150, and an outputter 160.

The communication interface 140 may receive various types of contents. For example, the communication interface 140 may receive various types of contents from an external device (e.g., a source device), an external storage medium (e.g., USB memory), an external server (e.g., web hard), or the like, using communication methods, such as an access point (AP)-based Wi-Fi (wireless LAN network), Bluetooth, Zigbee, wired/wireless local area network (LAN), wide area network (WAN), Ethernet, IEEE 1394, high definition multimedia interface (HDMI), universal serial bus (USB), mobile high-definition link (MHL), advanced encryption standard (AES)/European broadcasting union (EBU), optical, coaxial, or the like. The content may include a video signal, an article, text information, a posting, or the like.

The communication interface 140 according to an embodiment may transmit, to an external device, information for identifying the identification information 40 of the content 10 and the one region 11 of the content 10, according to a control of the processor 130.

The communication interface 140 according to one embodiment may receive marking information associated with the content 10. The processor 130 may then display the marker in one region of the scroll bar based on the received marking information. Here, the marking information may include information about the identified region of the content 10 based on a marker generated in the content 10 by another user. For example, if the content 10 is an article, each of the plurality of users who subscribe to the article may generate a marker in the region of interest. According to an embodiment of the disclosure, the external device can transmit, to a server, marking information including location information, representative keyword information, or the like, of a region corresponding to the marker generated by another user in the article. The server may then transmit articles and corresponding marking information to the display apparatus 100 viewing the article of interest. The display apparatus 100 may then display the articles and a scroll bar for scrolling the articles. The display apparatus 100 may display at least one marker generated by the other user in a corresponding region in the scroll bar based on the marking information.

According to an embodiment of the disclosure, the display apparatus 100 may not only display the content 10 but also provide the user with a marker (or scrap, a region of interest, and the like) generated by another user with respect to the content 10 along with the content 10.

As illustrated in FIG. 9, the processor 130 may obtain the summary information 50 based on the marker generated by the other user based on the marking information in addition to the marker generated according to the first user input 1.

Since the processor 130 obtains the summary information 50 based on the one region 10 corresponding to the marker 30 determined as the region of interest in the content 10 by a plurality of users, there is an effect of increasing the completeness, accuracy, and reliability of the summary information 50.

Meanwhile, the operation of obtaining the summary information 50 according to various embodiments may be performed by an external server other than the display apparatus 100, and may be implemented in a format that the display apparatus 100 receives the summary information 50 from an external server and displays the same.

In this case, the external server may receive marking information corresponding to the content 10 from the plurality of display apparatuses and obtain summary information 50 corresponding to the content 10 from the second artificial intelligence model 2000 using the received plurality of marking information.

The inputter 150 may be implemented as a device, such as, for example, and without limitation, a button, a touch pad, a mouse, and a keyboard, or a touch screen, a remote control transceiver capable of performing the above-described display function and operation input function, or the like. The remote control transceiver may receive a remote control signal from an external remote controller through at least one communication methods, such as an infrared rays communication, Bluetooth communication, or Wi-Fi communication, or transmit the remote control signal.

The display apparatus 100 may further include a tuner and a demodulator according to an embodiment. A tuner (not shown) may receive a radio frequency (RF) broadcast signal by tuning a channel selected by a user or all pre-stored channels among RF broadcast signals received through an antenna. The demodulator (not shown) may receive and demodulate the digital intermediate frequency (IF) signal and digital IF (DIF) signal converted by the tuner, and perform channel decoding, or the like. The input image received via the tuner according to an example embodiment may be processed via the demodulator (not shown) and then provided to the processor 130 for image processing according to an example embodiment.

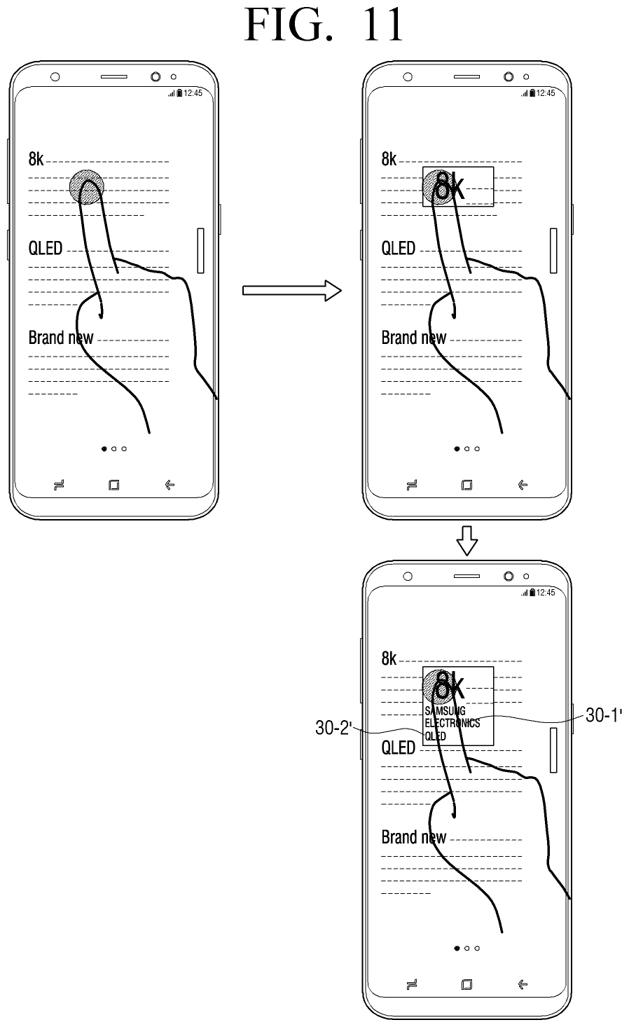

FIG. 11 is a diagram illustrating a marker according to an embodiment of the disclosure.

Referring to FIG. 11, the first user input 1 may be implemented with various types according to another embodiment.

For example, the processor 130 may identify the one region 11 as the region of interest and generate marker information corresponding to the one region 11, based on receiving a force touch input for the one region 11, or a touch input in excess of a threshold time. The marker information corresponding to the one region 11 can refer to a keyword corresponding to one region 11, the most frequent word among a plurality of words included in the one region 11, an image included in the one region 11, a capture image of the one region 11, or the like.

As another example, the processor 130 may identify the one region 11 as the user's interest region and may automatically generate marker information corresponding to the one region 11, based on the user input to move the scroll bar, or the indicating GUI not being received over a threshold time or an input to move content, such as upward/downward swipe, not being received over a threshold time, while the one region 11 is being provided through the display 110.

Referring to FIG. 11, the marker 30 may be displayed in various formats and positions, in addition to the scroll bar.

As illustrated in FIG. 11, the processor 130 according to an embodiment may generate a marker corresponding to the one region 11 based on receiving the force touch input in the one region 11.

The processor 130 may display the marker in a particular region of the scroll bar and may display the marker in a list form. For example, while a force touch is being received, the processor 130 may display all markers corresponding to content 10 in a list form.

Based on receiving a force touch input (or long press) in one region 11, the processor 130 may magnify and display the one region 11, and display a list of all markers corresponding to the content 10 at a lower end, for example, a first marker 30-1′ and a second marker 30-2′. Based on receiving the swipe input in a first direction (for example, upper side) in addition to the force touch input, the processor 130 may generate a marker corresponding to the one region 11.

As another example, the processor 130 may move to a region corresponding to a marker corresponding to a user input among a plurality of markers included in the list, e.g., the first marker 30-1′, the second marker 30-2′, when a swipe input is received in a second direction (e.g., lower direction), following a force touch input. For example, if the marker corresponding to the user input is the first marker 30-1′, the processor 130 may display a region corresponding to the first marker 30-1′ through the display 110.

Here, as shown in FIG. 2, the marker can be displayed as representative keyword information of a region corresponding to a specific region within the scroll bar. For example, referring to FIG. 11, the first marker 30-1′ corresponding to the first region 11-1 may be displayed as “Samsung Electronics” which is representative keyword information of the first region 11-1, and the second marker 30-2′ corresponding to the second region 11-2 may be displayed as “QLED”, which is representative keyword information of the second region 11-2. This is merely an embodiment of the disclosure, and the marker can be displayed in a variety of forms. For example, an image included in each region, a captured image for each region, and the like may be displayed.

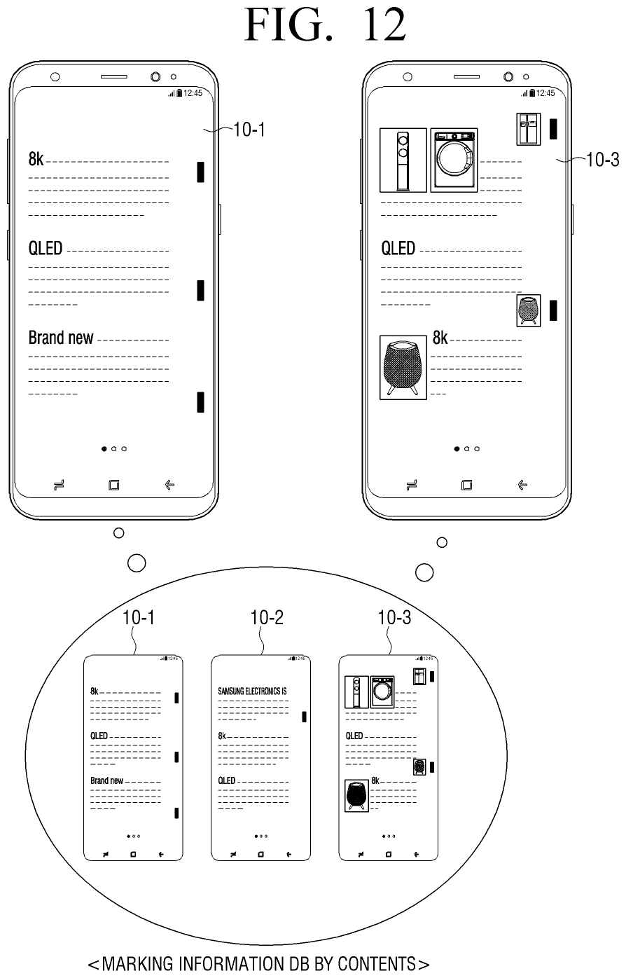

FIG. 12 is a diagram illustrating a method of storing a marker according to an embodiment of the disclosure.

Referring to FIG. 12, the processor 130 according to one embodiment may store marker information in the memory 120 in accordance with the generation of the marker 30. For example, the processor 130 may map the first content 10-1 and the marker 30 generated in the first content 10-1 to obtain marker information, and store the marker information in the memory 120. The processor 130 may then display the marker 30 mapped to the first content 10-1 based on the marker information when loading the first content 10-1.

As illustrated in FIG. 12, the marker 30 respectively corresponding to the first to third content 10-1, 10-2, 10-3 may be mapped and stored in the memory 120.

According to one embodiment of the disclosure, the processor 130 may display the third content 10-3 and the marker 30 mapped to the third content 10-3 based on the marker information when loading the third content 10-3.

The processor 130 according to an embodiment may transmit marker information to an external server or receive marker information from an external server.

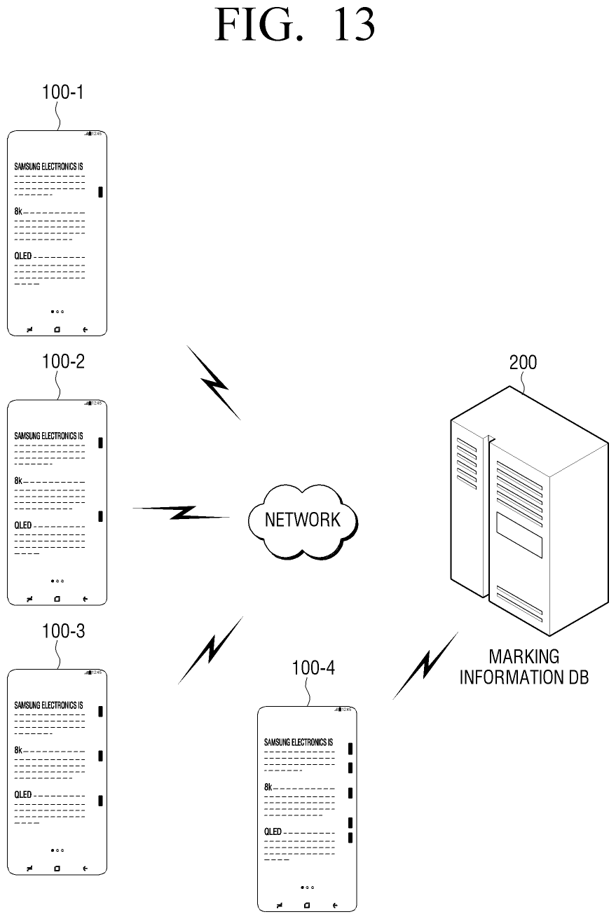

For example, the first content 10-1 and the marker 30 mapped to the first content 10-1 as illustrated in FIG. 12 may be generated by the display apparatus 100 or received from an external device (not shown). The detailed description thereof will be described with reference to FIG. 13.

FIG. 13 is a diagram illustrating a method of sharing a marker according to an embodiment of the disclosure.

Referring to FIG. 13, the display apparatus 100 according to an embodiment may map the content 10 and the marker 30 corresponding to the content 10 to generate marker information, and transmit the generated marker information to the external server 200.

As shown in FIG. 13, the marker information generated by the plurality of display apparatuses, such as the first display apparatus 100-1, the second display apparatus 100-2, and the third display apparatus 100-3 may be transmitted to the external server 200 through the network. The external server 200 may maintain and manage a database (DB) based on marker information received from a plurality of display apparatuses.

Based on the fourth display apparatus 100-4 loading the content 10, the external server 200 may transmit marker information based on the content 10 and the DB corresponding to the content 10.

Referring to FIG. 13, in addition to the content 10, the fourth display apparatus 100-4 may display together the markers 30 generated by another display apparatus (e.g., the first to third display apparatuses 100-1, 100-2, and 100-3) for the content 10.

As another example, the external server 200 may transmit the marker information to the fourth display apparatus 100-4 such that only a portion marked more than a threshold number of times within the content 10 is displayed based on the DB. For example, the fourth display apparatus 100-4 may display the content 10 and the marker 30 corresponding to the portion marked for more than a threshold number of times by other display apparatuses in the content 10.

As another example, the fourth display apparatus 100-4 may display the marker 30 corresponding to the marked portion greater than or equal to a threshold number of times with a different color or size than other markers.

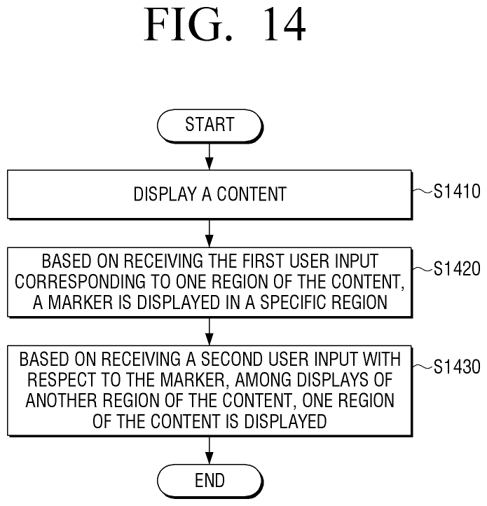

FIG. 14 is a flowchart illustrating a controlling method of a display apparatus according to an embodiment of the disclosure.

Referring to FIG. 14, according to a control method of the display apparatus of FIG. 14, a content is displayed first at operation S1410.

Based on receiving the first user input corresponding to one region of the content, a marker is displayed in a specific region at operation S1420.

Based on receiving a second user input with respect to the marker, among displays of another region of the content, one region of the content is displayed at operation S1430, wherein the specific region corresponds to one region in the scroll bar for scrolling the content.

According to an embodiment of the disclosure, the control method may further include an operation of controlling a marker displayed in a specific region based on receiving a third user input to the marker, and the third user input can be an input of a type different from the second user input.

The length of the scroll bar according to an embodiment may correspond to the entire length of the scrollable content, and the specific region may correspond to a relative position of the one region of the content with respect to the entire length of the content.

The displaying a marker at operation S1420 may further include, based on receiving a first user input, displaying a marker and identification information for identifying a content in one region at a specific region of the scroll bar corresponding to one region.

Here, the identification information for identifying the content of one region may include at least one of keyword information included in one region or a thumbnail image related to one region.

According to an embodiment of the disclosure, the operation of displaying a marker at operation S1420 may include obtaining representative keyword information corresponding to one region of content by using a first artificial intelligence model trained to obtain representative keyword information from input data, and displaying a marker and representative keyword information in a specific region of the scroll bar corresponding to one region.

The controlling method according to an embodiment may further include transmitting, to an external device, identification of content and information for identifying one region of a content.

The displaying a marker according to an embodiment at operation S1420 may include, based on receiving marking information related to a content, displaying a marker on one region of the scroll bar based on the marking information. Here, the marking information may include information on the identified one region of the identified content based on a marker generated in the content by another user.

According to an embodiment of the disclosure, a controlling method may further include the operations of obtaining summary information corresponding to content data corresponding to at least one marker displayed on a scroll bar and content data corresponding to the received marking information by using a second artificial intelligence model trained to obtain summary information from the input data, and displaying the obtained summary information.

According to an embodiment of the disclosure, the controlling method may further include the operations of displaying a list of interest regions including representative keyword information of a first region and representative keyword information of a second region, based on receiving the first user input corresponding to a first region of content and a first user input corresponding to a second region of the content, and displaying the first region of the content based on receiving a second user input with respect to the representative keyword information of the first region of the content.

The various embodiments can be applied to all electronic apparatuses capable of image processing, such as an image receiving device, an image processing device, and the like, such as a set-top box, as well as a display apparatus.

The various example embodiments described above may be implemented in a recordable medium which is readable by computer or a device similar to computer using software, hardware, or the combination of software and hardware. In some cases, embodiments described herein may be implemented by the processor 130 itself. According to a software implementation, embodiments of the disclosure, such as the procedures and functions described herein may be implemented with separate software modules. Each of the above-described software modules may perform one or more of the functions and operations described herein.

The computer instructions for performing the processing operations of the display apparatus 100 according to the various embodiments described above may be stored in a non-transitory computer-readable medium. The computer instructions stored in this non-transitory computer-readable medium cause the above-described specific device to perform the processing operations of the display apparatus 100 according to the above-described various embodiments when executed by the processor of the specific device.

The non-transitory computer readable medium may refer, for example, to a medium that stores data, such as a register, a cache, a memory or and the like, and is readable by a device. For example, the aforementioned various applications, instructions, or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

While the disclosure has been shown and described with reference to various embodiments thereof, it will be understood by those of skilled in the art that various changes in form and details may be made therein without departing from the spirit and scope of the disclosure as defined by the appended claims and their equivalents.

What is claimed is:

1. A display apparatus comprising:
a display;
a memory configured to store at least one instruction; and
a processor, connected to the display and the memory, configured to control the display apparatus,
wherein the processor is further configured to:
control the display to display a content,
based on receiving a first user input corresponding to a first region of the content, control the display to display a marker at a specific region of a scroll bar corresponding to a second region, and
based on receiving a second user input with respect to the marker, control the display to display the first region of the content.

2. The display apparatus of claim 1,
wherein the processor is further configured to, based on receiving a third user input with respect to the marker, remove the marker displayed on the specific region, and
wherein the third user input is an input of a type different from the second user input.

3. The display apparatus of claim 1,
wherein a length of the scroll bar corresponds to a total length of the scrollable content, and
wherein the specific region corresponds to a relative position in the first region of the content with respect to the total length of the content.

4. The display apparatus of claim 1, wherein the processor is further configured to, based on receiving the first user input, control the display to display the marker and identification information to identify the content in the second region, in the specific region of the scroll bar corresponding to the second region.

5. The display apparatus of claim 4, wherein the identification information to identify the content in the second region comprises at least one of keyword information included in the second region or a thumbnail image associated with the second region.

6. The display apparatus of claim 1,
wherein the memory is further configured to store a first artificial intelligence model trained to obtain representative keyword information from input data, and
wherein the processor is further configured to obtain representative keyword information corresponding to the first region of the content using the first artificial intelligence model, and control the display to display the marker and the representative keyword information in the specific region of the scroll bar corresponding to the second region.

7. The display apparatus of claim 1, further comprising:
a communication interface comprising circuitry,
wherein the processor is further configured to transmit, to an external device, identification information of the content and information to identify the second region, through the communication interface.

8. The display apparatus of claim 1, further comprising:
a communication interface comprising circuitry,
wherein the processor is further configured to, based on receiving marking information related to the content through the communication interface, control the display to display a marker in the specific region of the scroll bar based on the marking information, and
wherein the marking information comprises information on the first region of the content based on the marker generated in the content by another user.

9. The display apparatus of claim 8,
wherein the memory is further configured to store a second artificial intelligence model trained to obtain summary information from input data,
wherein the processor is further configured to:
obtain content data corresponding to at least one marker displayed on the scroll bar and obtain summary information corresponding to content data equivalent to the received marking information using the second artificial intelligence model, and control the display to display the obtained summary information.

10. The display apparatus of claim 1, wherein the processor is further configured to:
based on the receiving of the first user input corresponding to the first region of the content and the receiving of the first user input corresponding to the second region, control the display to display a list of an interested region including representative keyword information of the first region and representative keyword information of the second region, and
based on the receiving of the second user input with respect to the representative keyword information of the first region of the content, control the display to display the first region of the content.

11. The display apparatus of claim 1, wherein the processor is further configured to:
continuously display the scroll bar and an indicating graphical user interface (GUI) indicating a current scroll position, or based on receiving a user input to scroll the content, display the scroll bar and the indicting GUI during a threshold time.

12. A method of controlling a display apparatus, the method comprising:
displaying a content;
based on receiving a first user input corresponding to a first region of the content, displaying a marker at a specific region; and
based on receiving a second user input with respect to the marker in a display of another region of the content, displaying a second region of the content,
wherein the specific region is a region corresponding to the second region in a scroll bar for scrolling the content.

13. The method of claim 12, further comprising:
based on receiving a third user input with respect to the marker, removing the marker displayed on the specific region,
wherein the third user input is an input of a type different from the second user input.

14. The method of claim 12,
wherein a length of the scroll bar corresponds to a total length of the scrollable content, and
wherein the specific region corresponds to a relative position in the first region of the content with respect to the total length of the content.

15. The method of claim 12, wherein the displaying of the marker further comprises, based on receiving the first user input, displaying the marker and identification information to identify the content in the second region, in the specific region of the scroll bar corresponding to the second region.

16. The method of claim 15, wherein the identification information to identify the content in the second region comprises at least one of keyword information included in the second region or a thumbnail image associated with the second region.

17. The method of claim 12, wherein the displaying of the marker comprises:
obtaining representative keyword information corresponding to the second region of the content using a first artificial intelligence model trained to obtain representative keyword information from input data; and
displaying the marker and the representative keyword information in the specific region of the scroll bar corresponding to the second region.

18. The method of claim 12, further comprising:
transmitting, to an external device, identification information of the content and information to identify the second region of the content.

19. The method of claim 12,
wherein the displaying of the marker comprises:
based on receiving marking information related to the content, displaying a marker in the second region of the scroll bar based on the marking information, and
wherein the marking information comprises information on identified the second region of the content based on the marker generated in the content by another user.

20. The method of claim 12, further comprising:
obtaining content data corresponding to at least one marker displayed on the scroll bar and obtaining summary information corresponding to content data equivalent to the received marking information using a second artificial intelligence model trained to obtain summary information from input data; and
displaying the obtained summary information.
